(19) United States
(12) Patent Application Publication
(10) Pub. No.: US 2012/0145509 A1
(43) Pub. Date: Jun. 14, 2012

(54) ELECTROMECHANICAL ACTUATING ASSEMBLY

(75) Inventors: Gerhard Gumpoltsberger, Friedrichshafen (DE); Matthias Reisch, Ravensburg (DE); Benjamin Schneider, Friedrichshafen (DE)

(73) Assignee: ZF FRIEDRICHSHAFEN AG, Friedrichshafen (DE)

(21) Appl. No.: 13/391,421

(22) PCT Filed: Aug. 12, 2010
(86) PCT No.: PCT/EP2010/061774

§ 371 Date: Feb. 21, 2012

(30) Foreign Application Priority Data
Aug. 31, 2009 (DE) 10 2009 029 008.7

(51) Int. Cl. F16D 28/00; F16H 59/02

(52) U.S. Cl. 192/84.6; 74/473.12; 192/84.7

(57) ABSTRACT

An electromechanical actuating assembly for at least an actuator element of a vehicle transmission with at least a drive device which is coupled with to an actuator device to activate an actuator element. The actuator device comprises of a toggle lever mechanism which is actuated by a ramped contour.

This application is a national stage completion of PCT/EP2010/061774 filed Aug. 12, 2010 which claims priority from German Application Serial No. 10 2009 029 008.7 filed Aug. 31, 2009.

### FIELD OF THE INVENTION

The present invention concerns an electromechanical actuating assembly for at least one actuator element of a vehicle transmission.

### BACKGROUND OF THE INVENTION

Known, for instance, from the publications US 2006/0 278 489 A1 and DE 102 58 836 A1 are electromechanical clutch actuators for a vehicle clutch, where their adjustments are controlled via an additional, pneumatic or hydraulic system. The clutch actuator which is known from DE 102 58 836 A1 comprises, for instance, a magnetic valve with which a pressure equalization channel between two piston chambers is opened or closed, to control the movement of settings. These configurations result in complicated structures which require significant construction space.

Known from the publication DE 101 56 348 C1 is an electromechanical brake. The known brake has the disadvantage that larger adjustment forces are required for actuating the brake. Due to the complicated construction, a large number of components are required so that a significant amount of space is required.

### SUMMARY OF THE INVENTION

The present invention has the task to improve an electromechanical actuating assembly of the above described type in a way, such that the best possible compact construction is realized and possibly very little adjustment forces are required.

This task is solved in accordance with the invention.

Thus and in accordance with the invention, an electromechanical actuating assembly is proposed for at least an actuator element or similar for a vehicle transmission having at least a drive device, which is coupled with an actuator device to actuate the switching elements, whereby the actuator device comprises of a toggle lever mechanism which is actuated by a ramped contour or similar.

In this way, an actuating assembly is proposed with a lower space requirement, because the actuating assembly can be realized with lesser components. Furthermore, the proposed actuating assembly already generates a large transmission ratio even with low actuator forces by means of the toggle lever mechanism which is actuated by the ramped contour. With the electromechanical actuating assembly, a savings of power can be achieved in comparison to hydraulic drives, due to the reduction of required hydraulic power. Also, this produces required power matching of the energy supply through the onboard power for one system of the vehicle for the electric drive device of the invented actuating assembly. In addition, expensive ducts and hydraulic components can be avoided, which are required for a hydraulic drive device. An additional advantage is the fact that the inventive actuating assembly can also realize a start-stop function of a combustion engine and a hybrid drive.

In the context of an especially, advantageous embodiment variation of the invention, it can be provided that the actuating assembly can be applied for the actuation of a multidisc clutch of a transmission, wherein it is preferable that the toggle lever mechanism is positioned essentially coaxial with the transmission shaft. Hereby, this results in an especially compact construction and a minimum of space is required. However also other possibilities of the configuration can be envisioned, which can also reduce the required space.

Preferably, the actuator device can comprise of a spindle drive or similar which is driven by the drive device, the spindle drive essentially moves the ramped contour to actuate the toggle lever mechanism in the axial direction. Through the concept of sloping, which is realized by the ramped contour which is driven by the drive device or rather the spindle drive, the required actuator force can be transmitted in the simplest manner to the toggle lever mechanism.

Another embodiment of the invention can provide that the toggle lever mechanism can, for instance, comprise a toggle lever element or similar which is in operating connection with the ramped contour, and with an actuator lever which is in operating connection with the actuator element to be actuated. Through this actuator lever with a lever-toggle element combination, only low actuating forces are required to actuate the actuator elements. In addition, another advantageous result is the actuator force-free holding area or rather dead spot in the actuating assembly.

With this inventive actuating assembly, the ramped contour can create an axial force towards the toggle lever element so that the toggle lever element is moved radially to the outside, and whereby the actuator lever is pressed against the actuator element for its actuation. For instance, the toggle lever element can be realized as a rotationally symmetrical, bendable sheet metal plate or similar and the ramped contour as a ball ramp or similar. Also other constructive options can be envisioned.

The created axial force is bridged radially to the outside by means of the toggle lever element, thus pressing the actuator lever against the actuator element, it can be provided that one end of the actuator lever is connected by means of a joint with the toggle lever element and the other end of the actuator lever is fixed to the housing. Other constructive designs can also be applied, which meet the previously described functionality.

A preferred area of an application of the actuating assembly in accordance with the invention is the use in a transmission to actuate a multidisc clutch which is designed as the actuator element, whereby the drive device comprises of an electric motor which drives a spindle drive for the axial movement of the ramped contour or rather ball ramp.

### BRIEF DESCRIPTION OF THE DRAWINGS

In the following, the invention is further explained based on the drawings. which show:

FIG. 1 a schematic presentation of the general operating principle of an actuating assembly in accordance with the invention; and

FIG. 2 a sectional cut and partial view of the invented actuating assembly in the transmission enclosure of a vehicle.

### DETAILED DESCRIPTION OF THE PREFERRED EMBODIMENTS

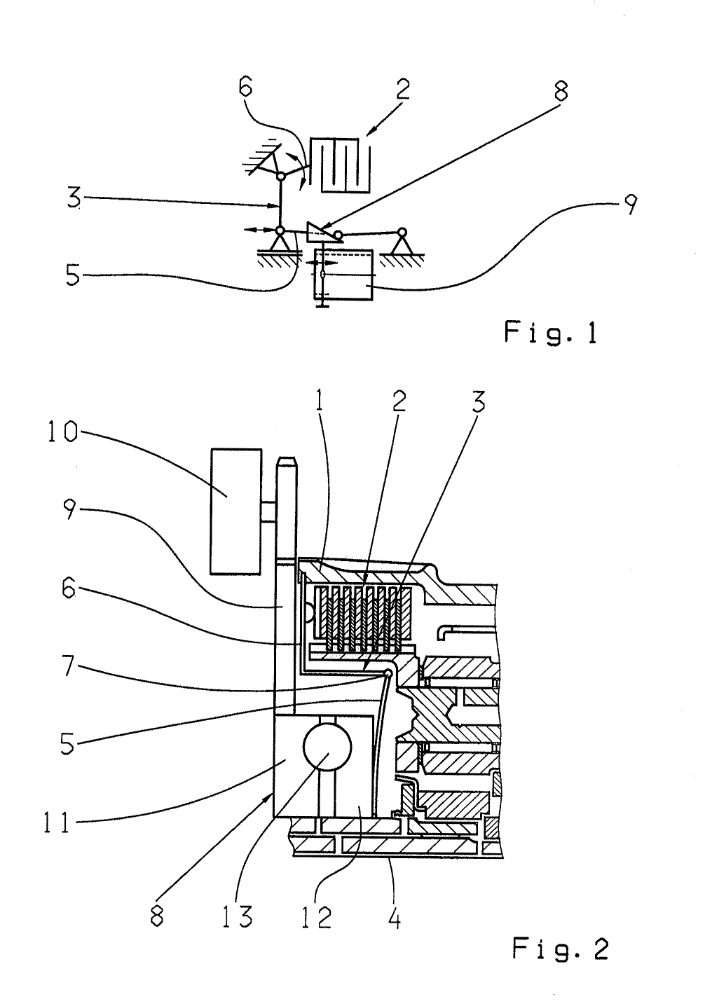

FIG. 1 illustrates the general operating principle of the proposed electromechanical actuating assembly. It can be seen in the drawing that the actuating assembly with a drive device actuates an actuator device which comprises of a spindle drive 9, a ramped contour and a toggle lever mechanism 3, such that the toggle lever mechanism 3 is moved accordingly to apply a predetermined positioning force to an actuator element which needs to be actuated. The actuator device is designed with just a few parts, so that the number of required parts is significantly reduced as compared to known actuating assemblies.

FIG. 2 presents a possible embodiment variation of the proposed actuating assembly in a transmission enclosure 1 of a motor vehicle. The electromechanical actuating assembly comprises a drive device which is coupled with an actuator device to actuate an actuator element which is designed as a multidisc clutch 2, wherein the actuator device comprises of a toggle lever mechanism 3 which is actuated by a ramped contour, to transfer a desired actuator force to the multidisc clutch 2. The toggle lever mechanism 3 is positioned in the transmission housing 1, coaxial to a transmission shaft 4 which is merely suggested in the drawing. This embodiment results in an especially construction space saving configuration.

The toggle lever mechanism 3 comprises of a toggle lever element 5 and an actuator lever 6 which are coupled together via a joint 7. The toggle lever element is, for instance, designed as a rotationally symmetrical, and bendable sheet metal plate. A ball ramp 8 is provided as a ramped contour, which on one hand is driven with a spindle drive 9 that is driven by an electric motor 10 which is driven in the direction of the drive and, on the other hand, is coupled with the toggle lever element 5. The ball ramp 8 can, for instance, be designed as a split ring element or similar, wherein a first half 11 is assigned to the spindle drive 9, and a second-half 12 with the ramped contour is associated with the toggle lever element 5. Both halves 11, 12 have as bearings several roller elements 13 arranged next to each other. Other constructive embodiments are also possible to realize the ramped or rather sloping contour.

The actuator lever 6 is a rotational part which has a bearing, that is supported by the transmission housing 1, at an end opposite from the end which faces from the toggle lever element 5, and which has a housing mounted lever bearing, respectively, so that movement of the toggle lever element 5 results in actuating movement of the actuator lever 6, so that it is pressed against the plates of the multidisc clutch 2. The actuation or rather rotation of the actuator lever 6 is marked in the drawing by an arrow. Also, the movement of the toggle lever element 5 and also the axial movement of the ball ramp 8 or the spindle nut of the spindle drive 9, respectively, are marked by respective arrows in FIG. 1.

Thus, in the inventive actuating assembly, the toggle lever element 5 is moved in the axial direction by the second half 12 of the ball ramp 8 which is actuated by the spindle drive 9, so that the toggle lever element 5 moves radially towards the outside. The configuration of the two levers, meaning the actuator lever 6 and the toggle lever element 5, enable a large transmission ratio at a low actuator force at the ball ramp 8. In addition, the actuating assembly can rest in the dead spot of the toggle lever element 5 without any actuator force.

### REFERENCE CHARACTERS

1. Transmission Housing
2. Multidisc Clutch
3. Toggle Lever Mechanism
4. Transmission Shaft
5. Toggle Lever Element
6. Actuator Lever
7. Joint
8. Ball Ramp
9. Spindle Drive
10. Electric Motor
11. First half of a divided Ring Element
12. Second half of a divided Ring Element
13. Roller Element

1-9. (canceled)

10. An electromechanical actuating assembly for at least an actuator element of a vehicle transmission, the electromechanical actuating assembly comprising:
at least a drive device which is coupled with an actuator device for actuating the actuator element, and
the actuator device comprising of a toggle lever mechanism (3) being actuated by a ramp contour.

11. The electromechanical actuating assembly according to claim 10, wherein the actuator element is a multidisc clutch (2) of the transmission, and the toggle lever mechanism (3) is positioned coaxially with a transmission shaft (4) of the transmission.

12. The electromechanical actuating assembly according to claim 10, wherein the actuator device comprises a spindle drive (9) which is driven by the drive device (10) to bias the ramp contour axially and actuate the toggle lever mechanism (3).

13. The electromechanical actuating assembly according to claim 10, wherein the toggle lever mechanism (3) comprises of a toggle lever element (5) which is operatively connected with the ramp contour and an actuator lever (6) which is operatively connection with the actuator element.

14. The electromechanical actuating assembly according to claim 13, wherein the ramp contour applies an axial force to the toggle lever element (5) such that the toggle lever element (5) is moved radially to an outside, so that the actuator lever (6) can be pressed against the actuator element.

15. The electromechanical actuating assembly according to claim 13, wherein the toggle lever element (5) is a rotationally symmetric, bendable sheet metal plate.

16. The electromechanical actuating assembly according to claim 12, wherein the ramp contour is a ball ramp (8).

17. The electromechanical actuating assembly according to claim 12, wherein one end of the actuator lever (6) has a bearing via a joint (7) with the toggle lever element (5) and an opposite end of the actuator lever (6) is fixedly attached to a housing of the transmission.

18. The electromechanical actuating assembly according to claim 12, wherein the drive device comprises of an electric motor (10) which drives a spindle drive (9) for inducing axial movement of the ramp contour.

19. An electromechanical assembly for actuating a clutch of a motor vehicle transmission, the electromechanical assembly comprising:
a toggle level mechanism (3) having a radially outer end that is fixed to a transmission housing (1) and a radially inner end that abuts a ball ramp (8), and the toggle lever mechanism (3) being coaxial with a transmission shaft;
the clutch (2) being axially aligned adjacent one side of the toggle level mechanism (3);
an electric drive motor (10) communicating with the ball ramp (8) such that rotational drive from the drive motor (10) being converted into axial drive by the ball ramp (8); and
the ball ramp (8) abutting the radially inner end of the toggle level mechanism (3), on a side of the toggle level mechanism (3) opposite from the clutch (2), such that axial drive of the ball ramp (8) axially biases the radially inner end of the toggle level mechanism (3).
